(19) United States
(12) Patent Application Publication
(10) Pub. No.: US 2014/0122256 A1
(43) Pub. Date: May 1, 2014

(54) METHODS AND SYSTEMS FOR TRANSFORMING MARKETING CAMPAIGN DESIGNS USING DOMAIN ONTOLOGIES

(71) Applicants: Dale Ellen GAUCAS, Penfield, NY (US); Michael David Shepherd, Ontario, NY (US); Ranen GOREN, Closer, NJ (US)

(72) Inventors: Dale Ellen GAUCAS, Penfield, NY (US); Michael David Shepherd, Ontario, NY (US); Ranen GOREN, Closer, NJ (US)

(73) Assignee: XEROX CORPORATION, Norwalk, CT (US)

(21) Appl. No.: 13/665,854

(22) Filed: Oct. 31, 2012

(51) Int. Cl. G06Q 30/02

(52) U.S. Cl. 705/14.73

(57) ABSTRACT

Methods, systems, and computer-readable media for transforming marketing campaign designs into a format capable of importation into a content management system using domain ontologies. A computing device can receive a model flattened domain ontology and can create a vocabulary and content types for a CMS. Additionally, the computing device can receive a model-based marketing campaign design. Using the model-based marketing campaign design, the computing device can create an instance of a domain ontology and can transform the domain ontology into a flattened domain ontology using the model flattened domain ontology. The flattened domain ontology can be used to create instances of the content types in the CMS, and the CMS can facilitate the production, storage, and access of documents formatted to present the information from the model-based marketing campaign design in a user-friendly format.

### TECHNICAL FIELD

The present disclosure relates generally to methods, systems, and computer-readable media for transforming campaign designs using domain ontologies and storing, accessing, and presenting the transformed campaign designs through the use of a content management system.

### BACKGROUND

Model-based design technologies allow for the collaborative creation and design of personalized marketing campaigns. For example, personalized marketing campaigns can be designed to incorporate various marketing campaign products, such as direct mailings, flyers, coupons, bulk electronic mail (“email”) messages, social media products, etc. However, campaigns presented in a model-based design environment may be cumbersome to navigate, and the impact of the campaign may be difficult to ascertain or replicate.

Therefore, there is a need for methods, systems, and computer-readable media for transforming a model-based marketing campaign design into a format usable in a content management system (“CMS”), allowing for storage and access of the marketing campaign content and a user-friendly presentation of the marketing campaign.

### SUMMARY OF THE INVENTION

The present disclosure relates generally to methods, systems, and computer-readable media for instantiating a domain ontology based on a model-based marketing campaign design and mapping the domain ontology into a CMS, allowing for storage and access of the marketing campaign content and a user-friendly presentation of the marketing campaign. The domain ontology includes concepts that describe the marketing campaign domain in general, and instances of those concepts, also known as individuals, for a specific marketing campaign.

In some embodiments, a model flattened domain ontology can be imported, which can map the transformation from a domain ontology that contains a deeply nested taxonomy of concepts to a flattened domain ontology that is un-nested. Terms from the model flattened domain ontology can be mapped to a vocabulary for a CMS, and content types and content fields can be created for the CMS based on the model flattened domain ontology.

In further embodiments, a domain ontology can be instantiated from a model-based marketing campaign design using methods known to those skilled in the art. For example, the domain ontology can be instantiated using the methods described in U.S. patent application Ser. No. 13/412,450.

In certain implementations, the domain ontology can be transformed into a flattened domain ontology using the imported model flattened domain ontology. Based on the flattened domain ontology and mapped vocabulary terms, content types, and content fields, the flattened domain ontology can be imported into the CMS, allowing for storage and access of the marketing campaign content and a user-friendly presentation of the marketing campaign.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a diagram depicting an exemplary network configuration that may be used to perform one or more operations of the described embodiments, consistent with certain disclosed embodiments;

FIG. 2 is a diagram depicting an exemplary hardware configuration for various devices that may be used to perform one or more operations of the described embodiments, consistent with certain disclosed embodiments;

FIG. 3 is a flow diagram illustrating an exemplary method for using a model flattened domain ontology to create and map vocabulary terms, content types, and fields for use in a CMS, consistent with certain disclosed embodiments;

FIG. 4 is a flow diagram illustrating an exemplary method of instantiating a domain ontology, a flattened domain ontology, content types, and fields based on a model-based marketing campaign design for insertion into a CMS, consistent with certain disclosed embodiments; and

FIG. 5 is a diagram depicting an exemplary document created from a model-based marketing campaign design, consistent with certain disclosed embodiments.

### DETAILED DESCRIPTION

The following detailed description refers to the accompanying drawings. Wherever convenient, the same reference numbers are used in the drawings and the following description to refer to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

A model-based marketing campaign design can be utilized to describe campaign semantics through the use of marketing concepts. Each marketing concept can be associated with a variety of unique properties and other concepts.

The model-based marketing campaign design can be used to create an instance of a domain ontology for the marketing campaign, for example, using the methods described in U.S. patent application Ser. No. 13/1412,450. The domain ontology includes concepts that describe the marketing campaign domain in general, and instances of those concepts, also known as individuals, for a specific marketing campaign.

For example, a domain ontology instantiated from a model-based marketing campaign design can have an individual entitled “East Coast (US)” of type “Campaign” where “Campaign” is a concept in the domain ontology. An example of the Campaign individual East Coast (US) can be textually represented as:

Name: East Coast (US)

Type: Campaign

Properties: Description—STRING—“Campaign targeting the East Coast of the United States.”
Number of Touchpoints—INTEGER—3
Touchpoints—List of Touchpoints—
   Direct Mail—Touchpoint
   Email—Touchpoint
   Website—Touchpoint

Accordingly, the Campaign individual entitled East Coast (US) can be associated with a property entitled “Description.” A Description can be a variable property of type “STRING” and, in the above instance, is set with the textual STRING value “Campaign targeting the East Coast of the United States.” Further, the East Coast (US) individual can be associated with a variable property entitled “Number of Touchpoints.” Number of Touchpoints can be a property of type “INTEGER,” set, in the above instance, with a value of 3.

Additionally, the East Coast (US) individual can be associated with a list of instances of a Touchpoint concept: Direct Mail, Email, and Website. As an example, the Touchpoint individual entitled Direct Mail can be textually represented as:

Name: Direct Mail

Type: Touchpoint

Properties: Description—STRING—“Delivery of advertising material to potential customers through postal mail.”
Targeted—BOOLEAN—YES
Post Card—Message
10% off Coupon—Incentive

Accordingly, the Touchpoint individual entitled Direct Mail can be associated with a property entitled “Description.” The Description property can be variable, and, in the above instance, can be a property of type “STRING” and can be associated with a textual string “Delivery of advertising material to potential customers through postal mail.” Further, a Touchpoint individual can be associated with a variable property entitled “Targeted.” Targeted can be a property of type “BOOLEAN,” where, in the above instance, the Boolean value is set to YES. The Touchpoint individual entitled Direct Mail can also be associated with an instance of a Message concept type entitled Post Card and an instance of an Incentive concept type entitled 10% off Coupon, which can include additional properties.

Unfortunately, neither the model-based structure, nor the domain ontology may be capable of direct importation into a CMS. Accordingly, a model flattened domain ontology can be used to map the domain ontology into a format that facilitates importation into a CMS. The model flattened domain ontology includes a subset and/or transformation of the concepts and concept relationships in the domain ontology, allowing for a mapping to a suitable representation of campaign content in a CMS. As an example, a model flattened domain ontology can be created manually from the concepts and properties in a domain ontology using transformation rules. Rules may include, but are not limited to: replacing a property (with a range that is a concept) with a STRING property whose values are restricted to a vocabulary derived from the structure (e.g., the names of the subconcepts) of the concept or from the named individuals for that concept that are permanently part of the domain model; moving a property from a sub-concept of a concept to the concept, and then removing the sub-concept; transforming a non-string property of a first concept to a STRING property for a second concept where the STRING property is derived from a STRING property of the first concept, and then removing the first concept.

Accordingly, in embodiments, a model flattened domain ontology can include a Campaign concept that includes a Description STRING variable and a Number of Touchpoints INTEGER variable. Further, the model flattened domain ontology can include references to Touchpoint concept types. In certain embodiments, an additional File STRING variable may be used to contain a file location for accessing the original campaign design file produced by the model-based design environment.

Additionally, the model flattened domain ontology may include a Touchpoint concept that includes properties, such as a Description STRING variable, a Targeted BOOLEAN variable, a Message STRING variable, and a Graphic IMAGE variable. Notably, the model flattened domain ontology may not include references to Message concept types or Incentive concept types.

A flattened domain ontology can be created using a domain ontology and a model flattened domain ontology. The concepts and properties of the model flattened domain ontology can be mapped from concepts and properties of the domain ontology based on flattening transformation rules such as those discussed above. For example, using the domain ontology and the model flattened domain ontology described above, the Campaign concept and properties of the domain ontology can be mapped into the Campaign concept in the model flattened domain ontology. Accordingly, a Campaign individual entitled East Coast (US) in the flattened domain ontology can be textually represented as shown above for the domain ontology.

Further, the Description and Targeted properties of the Touchpoint concept in the domain ontology can be mapped into the Touchpoint concept in the model flattened domain ontology. Additionally, the Message and Graphic properties in the model flattened domain ontology can be mapped from relevant properties of the Message and Incentive concepts in the domain ontology. Accordingly, for example, a Touchpoint individual entitled Direct Mail in the flattened domain ontology can be textually represented as:

Name: Direct Mail

Type: Touchpoint

Properties: Description—STRING—“Delivery of advertising material to potential customers through postal mail.”
Targeted—BOOLEAN—YES
Message—STRING—“To our valued [region] customer, please enjoy this 10% off coupon on your next visit”
Graphic—IMAGE—coupon.jpg
File—STRING—/campaigndesigns/original.mbd

Accordingly, the Touchpoint individual entitled Direct Mail in the flattened domain ontology can be associated with a property entitled “Description.” A Description can be a property of type “STRING” and can be associated with a textual string “Delivery of advertising material to potential customers through postal mail.” Further, a Touchpoint individual can be associated with a property entitled “Targeted.” Targeted can be a property of type “BOOLEAN,” where the Boolean value is set to YES. The Touchpoint individual can also be associated with the property “Message,” where the STRING value can be set from information in the Message individual entitled Post Card from the domain ontology, and with the property “Graphic,” where the IMAGE value can be set with an image file included as part of the Incentive individual entitled 10% off Coupon in the domain ontology. Further, the Touchpoint individual can also be associated with the property “File.” The STRING value of the File property can, in embodiments, be set as “/campaigndesigns/original.mbd,” which can represent the address for accessing the original campaign design file.

It is possible that some properties or concepts may not be mapped to the model flattened domain ontology. For example, the model flattened domain ontology may not include mapped equivalents for all information from the Incentive concept type in the domain ontology. Accordingly, such information may not be included when a flattened domain ontology is instantiated and imported into a CMS.

In embodiments, the model flattened domain ontology can be utilized to create a vocabulary for use in importing instances of flattened domain ontologies into a CMS. For example, the vocabulary can include terms for the concept types “Touchpoint” and “Campaign,” and the properties “Description” and “Number of Touchpoints” in the Campaign concept type, and “Description,” “Targeted,” “Message,” and “Graphic” in the Touchpoint concept type.

Further, certain terms in the vocabulary may be used as allowable values for STRING properties as determined by flattening transformation rules such as those discussed above. For example, a “Market” STRING property for the concept type “Campaign” could be restricted to the terms “retail” and “non-profit”.

Additionally or alternatively, content types and fields for a CMS can be created based on the vocabulary. For example, a content type “Touchpoint” can be created, which includes fields “Description,” “Targeted,” “Message,” and “Graphic.”

In embodiments, the created content types and fields can be mapped to the model flattened domain ontology. For example, the Touchpoint concept type can be mapped to the Touchpoint content type, and the “Description,” “Targeted,” “Message,” and “Graphic” properties can be mapped to the “Description,” “Targeted,” “Message,” and “Graphic” fields.

Once content types and fields are mapped to the model flattened domain ontology, an instance of a flattened domain ontology can be transformed, using the mappings, to a format capable of insertion into a CMS.

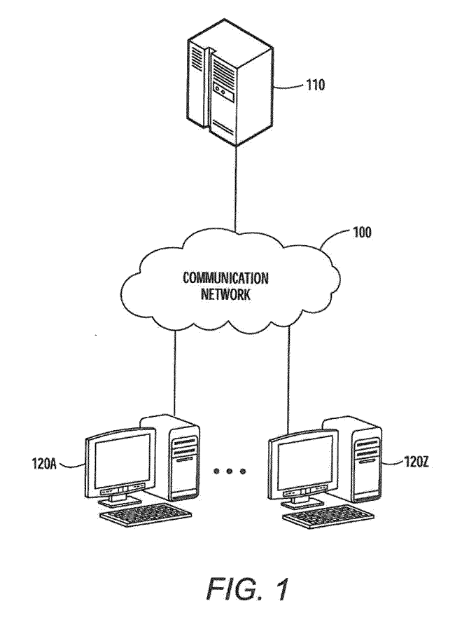

FIG. 1 is a diagram depicting an exemplary network configuration that may be used to perform one or more operations of the described embodiments, consistent with certain disclosed embodiments. As depicted in FIG. 1, a server 110 can communicate with one or more client devices 120a-120z through a communication network 100, such as the Internet.

Server 110 can represent any type of computing device configured by software operative to communicate with one or more client devices 120a through 120z via communication network 100 and perform the operations as disclosed herein, such as instantiating domain ontologies and flattened domain ontologies based on a model-based marketing campaign design. Server 110 is depicted in FIG. 1 as a single device, but different implementations may use multiple devices working independently or as a system.

Client machine 120a through 120z can be configured by software operative to perform various functions including, but not limited to, transferring information to server 110, requesting and receiving information from server 110, creating model flattened domain ontologies, creating model-based marketing campaign designs, and viewing documents, such as Hypertext Transfer Protocol (“HTML”) and/or Extensible Hypertext Markup Language (“XHTML”) pages, using one or more browsers.

For example, a first user may create a model flattened domain ontology using software located on client device 120a. The first user can import the model flattened domain ontology to server 110 using communication network 100. Server 110 can create and map vocabulary terms from the model flattened domain ontology to a CMS and can create content types and fields based on the model flattened domain ontology.

A second user can create a model-based marketing campaign design using software located on a client device 120b (not pictured). The second user can then store the model-based marketing design on server 110. Server 110 can transform the model-based marketing campaign design by instantiating a domain ontology from the model-based marketing campaign design, instantiating a flattened domain ontology using the model flattened domain ontology imported by the first user, and import the flattened domain ontology into the CMS using the mapped vocabulary terms, content types, and fields created using the model flattened domain ontology. Server 110 can create documents, such as HTML pages, using the information imported into the CMS.

A third user can view the documents created by server 110 using a client device 120z. Client device 120z can request the documents from server 110 via communication network 100, and client device 120z can display the documents for the third user using, for example, a web browser.

Those skilled in the art will appreciate that the foregoing network arrangement is exemplary only. For example, in some embodiments, server 110 and/or any of client machines 120a-120z may be the same machine.

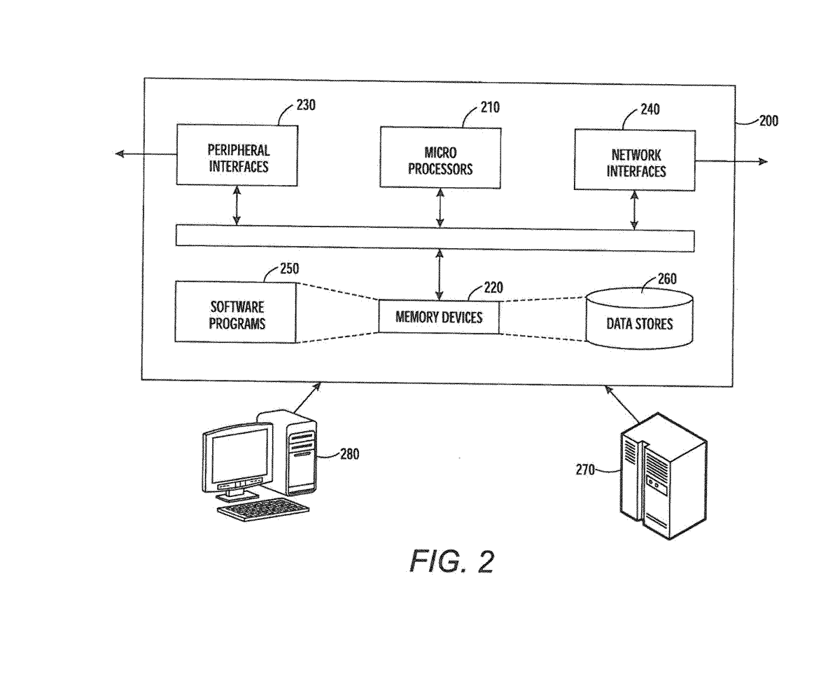

FIG. 2 is a diagram depicting an exemplary hardware configuration 200 for various devices that may be used to perform one or more operations of the described embodiments. As further described below, certain operations can be performed by one or more of client devices 280, which may be, for example, traditional personal computing devices, such as desktop or laptop computers; mobile devices, such as smartphones or tablets; kiosk terminals, etc. In embodiments, client device 280 can represent one or more of client devices 120a-120z, as depicted in FIG. 1. Various operations can additionally be performed by server 270, which may be a rack-mounted server device or a conventional desktop computing device, capable of serving web pages and executing server-side scripts or programs. In embodiments, server 270 can represent server 110, as depicted in FIG. 1.

Client devices 280 and/or server 270 may perform operations pursuant to executable or interpretable code resident in memory. In some cases, various operations performed by client device 280 may be performed pursuant to client-side code received from one or more external devices, such as server 270.

Devices 270 and 280 can comprise one or more microprocessors 210 of varying core configurations and clock frequencies; one or more memory devices or computer-readable media 220 of varying physical dimensions and storage capacities, such as flash drives, hard drives, random access memory, etc., for storing data, such as images, files, and program instructions for execution by one or more microprocessors 210; one or more network interfaces 240, such as Ethernet adapters, wireless transceivers, or serial network components, for communicating over wired or wireless media using protocols, such as Ethernet, wireless Ethernet, code divisional multiple access (CDMA), time division multiple access (TDMA), etc.; and one or more peripheral interfaces 230, such as keyboards, mice, touchpads, computer screens, touchscreens, etc., for enabling human interaction with and manipulation of devices 270 and 280. In some embodiments, the components of hardware configuration 200 need not be enclosed within a single enclosure or even located in close proximity to one another.

Memory devices 220 may further be physically or logically arranged or configured to provide for or store one or more data stores 260, such as one or more file systems or databases, and one or more software programs 250, which may contain interpretable or executable instructions for performing one or more of the disclosed embodiments. Those skilled in the art will appreciate that the above-described componentry is exemplary only, as devices 270 and 280 may comprise any type of hardware componentry, including any necessary accompanying firmware or software, for performing the disclosed embodiments. Devices 270 and 280 can also be implemented in part or in whole by electronic circuit components or processors, such as application-specific integrated circuits (ASICs) or field-programmable gate arrays (FPGAs).

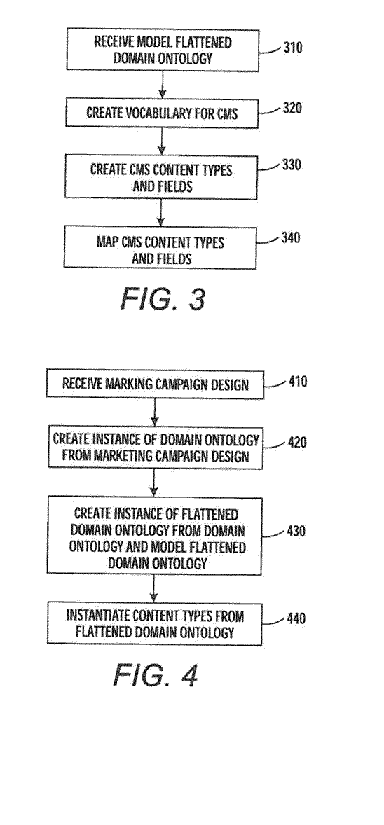

FIG. 3 is a flow diagram illustrating an exemplary method for using a model flattened domain ontology to create and map vocabulary terms, content types, and fields for use in a CMS, consistent with certain disclosed embodiments. The steps depicted in FIG. 3 may be performed using one or more computing devices, such as server 110 and one or more client machines 120a-120z over communication network 100, as depicted in FIG. 1.

In 310, a computing device can receive a model flattened domain ontology. For example, server 110 can receive the model flattened domain ontology from a user on client device 120a.

Using the model flattened domain ontology, in 320, the computing device can create vocabulary terms for importation into a CMS. For example, the terms can be created based on the concepts “Touchpoint” and “Campaign,” and the properties “Description” and “Number of Touchpoints” in the Campaign concept type and “Description,” “Targeted,” “Message,” and “Graphic” in the Touchpoint concept type.

In 330, the computing device can create content types and fields for the CMS based on the vocabulary terms. For example, the computing device can create a content type “Touchpoint,” which includes fields “Description,” “Targeted,” “Message,” and “Graphic.”

Finally, in 340, the computing device can map the content types and fields to the model flattened domain ontology. For example, the Touchpoint concept type can be mapped to the Touchpoint content type, and the “Description,” “Targeted,” “Message,” and “Graphic” properties can be mapped to the “Description,” “Targeted,” “Message,” and “Graphic” fields.

Those skilled in the art will appreciate that the foregoing sequence of steps is exemplary only, and that other sequences may be used for performing embodiments of the invention. For example, in some embodiments, various different concepts, properties, vocabulary terms, content types, and fields may be utilized.

FIG. 4 is a flow diagram illustrating an exemplary method of instantiating a domain ontology, a flattened domain ontology, content types, and fields based on a model-based marketing campaign design, for importation into a CMS, consistent with certain disclosed embodiments. The steps depicted in FIG. 4 may be performed using one or more computing devices, such as server 110 and one or more client machines 120a-120z over communication network 100, as depicted in FIG. 1.

In 410, the computing device can receive a model-based marketing campaign design. For example, a server can receive a model-based marketing campaign design via a communication network from a client machine.

In 420, the computing device can instantiate a domain ontology from the model-based marketing campaign design, for example, using methods described in U.S. patent application Ser. No. 13/412,450.

In 430, the computing device can instantiate a flattened domain ontology utilizing the domain ontology from 420 and a model flattened domain ontology, similar to the model flattened domain ontology received in 310, as described for FIG. 3.

Finally, in 440, the computing device can instantiate content types and fields using content types and fields that are mapped to the flattened domain ontology such as, for example, in step 340, as described for FIG. 3.

Those skilled in the art will appreciate that the foregoing sequence of steps is exemplary only, and that other sequences may be used for performing embodiments of the invention.

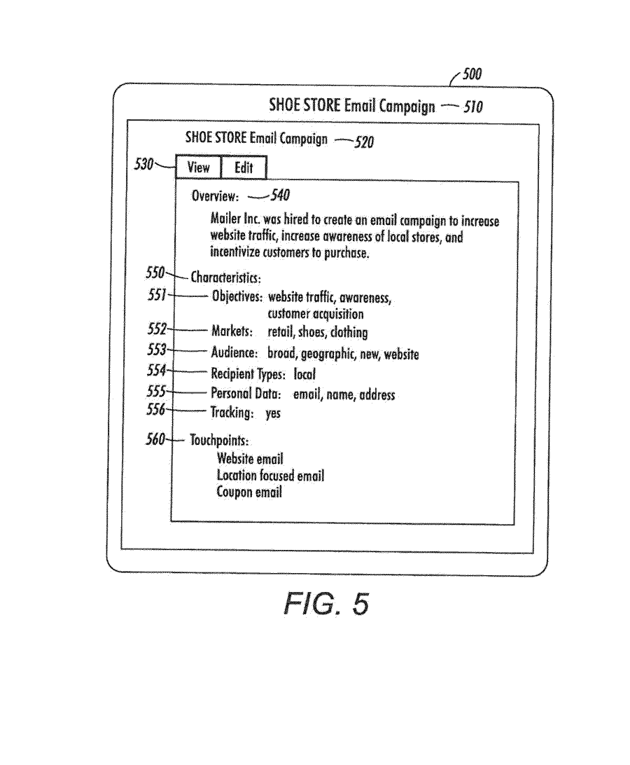

FIG. 5 is a diagram depicting an exemplary document created from a model-based marketing campaign design, consistent with certain disclosed embodiments. In some implementations, the document can be a web page viewable using a web browser implemented on a computing device. For example, the document can include textual information in HTML or XHTML format, and the document can provide navigation links to other web pages via hypertext links “links”). Additionally, the document can be viewed on a computing device such as, for example, client device 120a, as depicted in FIG. 1.

In embodiments, a document can represent a document created from a model-based marketing design using techniques as described above. Referring to FIG. 5, the document can be, for example, an HTML web page 500 viewable on a computing device using a web browser. The web browser can include a title bar 510 and may populate the title bar with a <title> element, which can be text included between a <title> start tag and a <title> end tag. For example, HTML web page 500 can include the text “SHOE STORE Email Campaign” between the <title> start and end tags, and such text can be displayed in the title bar of a web browser implemented on a computing device.

SHOE STORE Email Campaign can be a Campaign concept type created based on a model-based marketing campaign design, transformed into a format capable of importation into a CMS, as described above. The text “SHOE STORE Email Campaign” can be imported from, for example, a Name property in the domain ontology or the flattened domain ontology. Additionally, HTML web page 500 can include the title SHOE STORE Email Campaign 520 in the body of the web page.

In embodiments, HTML web page 500 can allow a user to edit information related to the marketing campaign using the web browser. For example, HTML web page 500 can include tabs 530. Tabs 530 can be interactive tabs that can allow a user to view the information on the page by clicking the View tab, or allow the user to edit the information on the page by clicking the Edit tab. In some implementations, HTML web page 500 may only allow specified users to edit information, or can require login and password information before allowing users to edit information.

HTML web page 500 can include fields populated with additional textual information from a model-based marketing campaign design and/or domain ontologies and flattened domain ontologies created from a model-based marketing campaign design. Such fields can include, but are not limited to: an Overview field 540; a Characteristics field 550, which can include, an Objectives field 551, a Markets field 552, an Audience field 553, a Recipient Types field 554, a Personal Data field 555, and a Tracking field 556; and a Touchpoints field 560.

As an example, HTML web page 500 can include Touchpoints field 560. Touchpoints field 560 can include the text “Website email,” “Location focused email,” and “Coupon email.” In some embodiments, some or all textual elements in the field can be links to additional web pages. For example, the text “Coupon email” can be a link that, when clicked, navigates a user to an additional web page that was created based on the model-based marketing campaign design that relates to a coupon email. Additional information about the coupon email can be displayed on such a web page, and the user can navigate to other information using similar links on each web page.

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. The steps described need not be performed in the same sequence discussed or with the same degree of separation. Likewise various steps may be omitted, repeated, or combined, as necessary, to achieve the same or similar objectives or enhancements. Accordingly, the invention is not limited to the above-described embodiments, but instead is defined by the appended claims in light of their full scope of equivalents.

What is claimed is:

1. A computer-implemented method comprising:
receiving a model flattened domain ontology, wherein the model flattened domain ontology comprises information associated with one or more concepts;
creating a vocabulary based on the model flattened domain ontology; and
creating, using one or more processors, one or more CMS content types based on the one or more concepts in the model flattened domain ontology.

2. The method of claim 1, wherein the one or more concepts are marketing concepts.

3. The method of claim 1, further comprising creating one or more CMS fields associated with the one or more CMS content types based on the information associated with the one or more concepts.

4. The method of claim 1, further comprising:
receiving a model-based marketing campaign design; and
creating one or more instances of the one or more CMS content types based on the model-based marketing campaign design.

5. The method of claim 4, further comprising creating an instance of a domain ontology based on the model-based marketing campaign design.

6. The method of claim 5, further comprising creating an instance of a flattened domain ontology based on the instance of the domain ontology and the model flattened domain ontology.

7. The method of claim 3, further comprising creating a document using the CMS, wherein:
the document is created based on the one or more CMS content types; and
the document includes textual information based on the one or more CMS fields associated with the one or more CMS content types.

8. The method of claim 7, wherein the textual information based on the one or more CMS fields comprises hypertext links associated with additional documents created based on the one or more CMS content types.

9. A system comprising:
a processing system comprising one or more processors; and
a memory system comprising one or more computer-readable media, wherein the computer-readable media contains instructions stored thereon that, if executed by the processing system, cause the system to perform operations comprising:
receiving a model flattened domain ontology, wherein the model flattened domain ontology comprises information associated with one or more concepts;
creating a vocabulary based on the model flattened domain ontology;
creating one or more CMS content types based on the one or more concepts in the model flattened domain ontology.

10. The system of claim 9, wherein the one or more concepts are marketing concepts.

11. The system of claim 9, the operations further comprising creating one or more CMS fields associated with the one or more CMS content types based on the information associated with the one or more concepts.

12. The system of claim 9, the operations further comprising:
receiving a model-based marketing campaign design; and
creating one or more instances of the one or more CMS content types based on the model-based marking campaign design.

13. The system of claim 12, the operations further comprising creating an instance of a domain ontology based on the model-based marketing campaign design.

14. The system of claim 13, the operations further comprising creating an instance of a flattened domain ontology based on the instance of the domain ontology and the model flattened domain ontology.

15. The system of claim 11, the operations further comprising creating a document using the CMS, wherein:
the document is created based on the one or more CMS content types; and
the document includes textual information based on the one or more CMS fields associated with the one or more CMS content types.

16. The system of claim 15, wherein the textual information based on the one or more CMS fields comprises hypertext links associated with additional documents created based on the one or more CMS content types.

17. A system comprising:
a processing system comprising one or more processors;
a network connection, where in the processing system can communicate with a server via the network connection; and
a memory system comprising one or more computer-readable media, wherein the computer-readable media contains instructions stored thereon that, if executed by the processing system, cause the system to perform operations comprising:
transferring a model flattened domain ontology to the server via the network connection, wherein:
the model flattened domain ontology comprises infouuation associated with one or more concepts; and
the server is configured to:
create a vocabulary based on the model flattened domain ontology; and
create one or more CMS content types based on the one or more concepts in the model flattened domain ontology.

18. The system of claim 17, the operations further comprising transferring information associated with a model-based campaign design to the server via the network connection.

19. The system of claim 17, the operations further comprising receiving one or more documents from the server, wherein:
the one or more documents comprise instructions for displaying textual information via a web browser; and
the one or more documents are associated with the one or more CMS content types.

20. The system of claim 19, wherein the textual information comprises hypertext links configured to allow for navigation between the one or more documents using the web browser.
